(19) United States
(12) Patent Application Publication
(10) Pub. No.: US 2014/0136435 A1
(43) Pub. Date: May 15, 2014

(54) SOCIAL MEDIA AND TRANSACTION DISPLAY SYSTEM

(71) Applicant: Frank Anthony Nuzzi, Pflugerville, TX (US)

(72) Inventor: Frank Anthony Nuzzi, Pflugerville, TX (US)

(73) Assignee: eBay Inc., San Jose, CA (US)

(21) Appl. No.: 13/678,420

(22) Filed: Nov. 15, 2012

(51) Int. Cl. G06Q 50/00

(52) U.S. Cl. CPC G06Q 50/01
USPC 705/319

(57) ABSTRACT

Systems and methods for displaying transaction data and social media are provided. In an embodiment, a receiver and record generation module generates a record of a transaction performed by a user. A transmission module sends a request for social media data related to the transaction and about the user to a network-based social platform. A receiver module receives at least one piece of social media data. A signal generation module provides a rendering signal instructing a client device to render at least a portion of the record of the transaction and the at least one piece of social media data.

### TECHNICAL FIELD

The subject matter disclosed herein generally relates to the processing of data. Specifically, the present disclosure addresses systems and methods of providing consent to a social network platform within a display of one or more transactions.

### BACKGROUND

Applications available on the Internet have progressed from facilitating a medium of information delivery to a venue for buying goods, paying bills and, more recently, to a platform for social networking. Online financial institutions such as Paypal.com® or Americanexpress.com® are examples of online payment systems. Similarly, Facebook.com® and twitter.com® are examples of social networking.

### BRIEF DESCRIPTION OF THE DRAWINGS

Some embodiments are illustrated by way of example and not limitation in the figures of the accompanying drawings in which:

FIG. 1 is a network diagram depicting a system, according to one example embodiment, having a client-server architecture;

FIG. 2 is a block diagram illustrating social applications, according to an embodiment;

FIG. 3A is a block diagram illustrating a database, according to an embodiment;

FIG. 3B is an illustration of a system usable with or as part of the system of FIG. 1;

FIG. 4 depicts a portion of a graphical user interface illustrating an operation of an application useful in an embodiment;

FIG. 5 depicts a portion of a graphical user interface illustrating an operation of an application useful in an embodiment;

FIG. 6 depicts a portion of a graphical user interface illustrating an operation of an application useful in an embodiment;

FIG. 7 depicts a portion of a graphical user interface illustrating an operation of an application useful in an embodiment;

FIG. 8 depicts a portion of a graphical user interface illustrating an operation of an application useful in an embodiment;

FIG. 9 depicts a portion of a graphical user interface illustrating an operation of an application useful in an embodiment;

FIG. 10 is a flowchart depicting example operations performed as part of an embodiment; and

FIG. 11 is a block diagram illustrating components of a machine, according to some example embodiments, able to read instructions from a machine-readable medium and perform any one or more of the methodologies discussed herein.

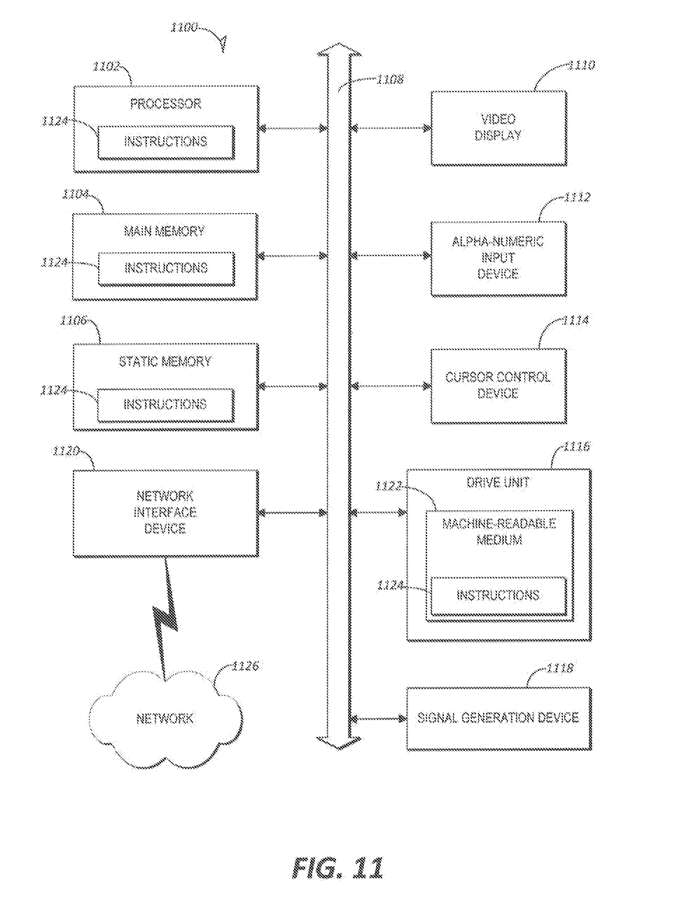

In the figures, the same or similar references have been used to indicate the same or similar features unless otherwise indicated.

### DETAILED DESCRIPTION

In the following description, for purposes of explanation, numerous specific details are set forth in order to provide embodiments of the subject matter set forth in the present disclosure. It will be evident, however, to one skilled in the art that the present disclosure may be practiced without these specific details.

Content may be provided over a network from a first server to a second server. The first server may be, for example, a web server, a database server, or a listing server. For example, a network-based financial institution may include a first web server that provides content over a network to the second web server. Specifically, the second server may be a social network server that provides a social networking service (e.g., Facebook®) to millions of users and provides social network data. Herein, the use of “Facebook” could as easily be Twitter® or any other social network service.

Each of the first server and second server may provide the content to one or more client machines, and these client machines may be the same client machine or a different client machine.

A client machine may be a computer, a mobile device, or other machine functioning, temporarily or permanently, as a client in relation to the content machine. For example, the client machine may, as indicated above, have a user. The user may be a human user or a machine-implemented user (e.g., software executing on the client machine). The content provided by the social network server may be presented to a client machine and then to the user by the client machine. Other couplings between these or similar servers and one or more client machines may be used.

More specifically, the social network server that provides content may, in turn, be provided content from a network-based financial institution. A network-based financial institution may provide a payment service to users. The payment service allows users to make electronic payments to merchants. The merchants may be online merchants, brick-and-mortar merchants, or some hybrid thereof. The payment service may provide information about a user and/or the user's purchase to the social network server.

The social network service, and the payment service, in combination, may publish, in one embodiment, information about items purchased by the user in a graphical user interface hosted by either the social network server or the network-based financial institution. The social network service, for example, may aggregate content related to the purchase from sources including the social network service and/or other social networking or online sources. The content may have been created by the user or other users before the purchase was made, concurrently with the purchase, or after the purchase was completed.

### Platform Architecture

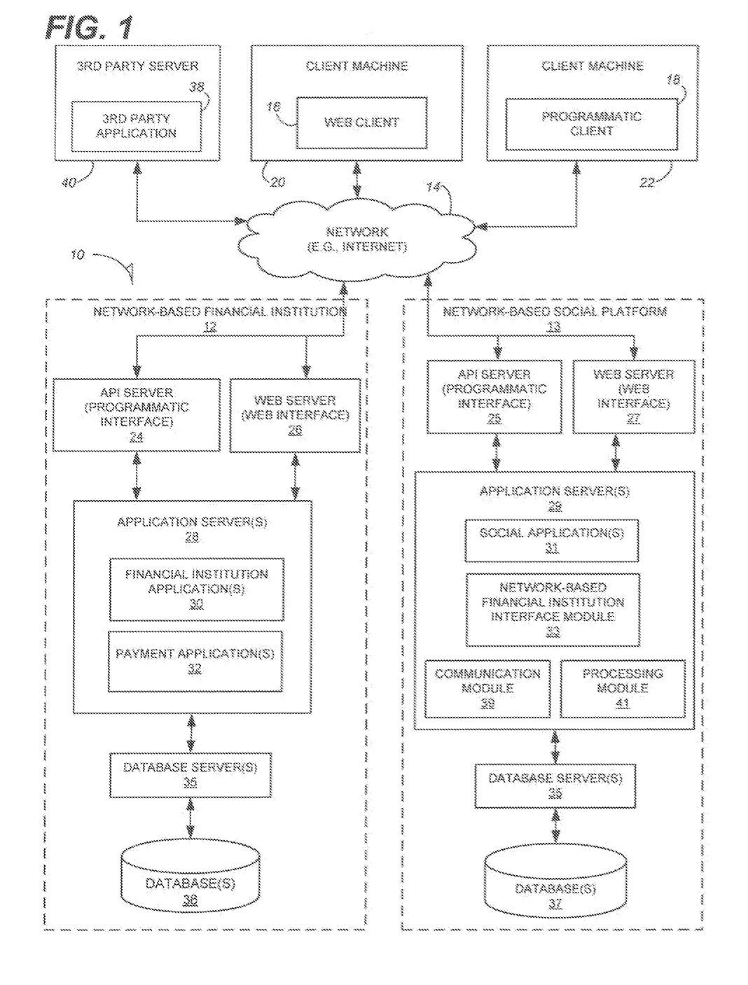

FIG. 1 is a network diagram depicting a system 100, according to one embodiment of the present disclosure, having a client-server and a peer-to peer architecture. The system 10 facilitates transaction-sharing activity, in the exemplary form of a network-based financial institution 12 and a network-based social platform 13 that communicate over a network 14. In one embodiment, the network-based financial institution 12 and the network-based social platform 13 communicate in peer-to peer architecture via programmatic interfaces. Further, the network-based financial institution 12 and the network-based social platform 13 respectively communicate in a client-server architecture with clients. The network-based financial institution 12 provides server-side functionality, via the network 14 (e.g., the Internet), to the one or more client machines 20 and 22. Similarly, the network-based social platform 13 provides server-side functionality, via the network 14 (e.g., the Internet), to the one or more client machines 20 and 22. FIG. 1 illustrates, for example, a web client 16 (e.g., a browser, such as the Internet Explorer browser developed by Microsoft Corporation of Redmond, Wash. State), and a programmatic client 18 executing on respective client machines 20 and 22.

Turning specifically to the network-based social platform 13, an application program interface (API) server 25 and a web server 27 are coupled to, and provide programmatic and web interfaces respectively to, one or more application servers 29. The application servers 29 may host one or more social applications 31 and a network-based financial institution interface module 33 that communicate with a communication module 39 and a processing module 41. The application servers 29 are, in turn, shown to be coupled to one or more database server(s) 35 that facilitate access to one or more database(s) 37.

The social applications 31 provide a number of social networking functions and services to users that access the network-based social platform 13. For example, the social applications 31 may enable a user to store information in a profile that may be viewed at the client machines 20, 22 and to selectively grant access to information that appears on the profile to other users who may also view the profile at their client machines 20, 22. The social applications 31 may provide criteria that may be employed by a user to grant various levels of access to various levels of users. For example, a first user may access profile information associated with a second user responsive to the first user achieving the status of “friend” in relation to a second user. A user may achieve the status of friend by accepting an invitation from another user or by sending a request to a user that subsequently grants the request.

The social applications 31 may further enable third-party service providers to add “applications” on the network-based social platform 13 that are utilized by user to interact with other users. For example, a network-based financial institution application may be added by a third-party service provider in the form of the network-based financial institution interface module 33, the communication module 39, and the processing module 41 that may provide market application services in the network-based social platform 13 environment and may communicate with the network-based financial institution 12.

In one embodiment, a request related to the financial institution applications 30 may be generally processed as follows. The request may originate at the client machines 20, 22 that communicate the request via API server 25 or web server 27 to the social applications 31 that, in turn, communicate the request to the network-based financial institution interface module 33, which in turn communicates the request to the communication module 39 and processing module 41 that process the request. Conversely, the communication module 39 and processing module 41 may respond to the social applications 31 via the network-based financial institution interface module 33. In some instance, processing of the request may require communication with the network-based financial institution 12. In such instances, the communication module 39 or the processing module 41 may communicate via the API server 25 with the network-based financial institution 12.

The network-based social platform 13 may be embodied as Facebook services, a social utility that connects people with friends and others who work, study and live around them provided by Facebook of Palo Alto, Calif. Another embodiment for the network-based social platform may be TWITTER® services, which is also a social utility, provided by Twitter of San Francisco, Calif.

The web client 16, it will be appreciated, accesses the various social applications 31 in one embodiment via the web interface supported by the web server 27. Similarly, the programmatic client 18 in one embodiment accesses the various services and functions provided by the social applications 31 via the programmatic interface provided by the API server 25.

Turning to the network-based financial institution 12, an API server 24 and a web server 26 are coupled to, and provide programmatic and web interfaces respectively to, one or more application servers 28. The application servers 28 host one or more financial institution applications 30 and payment applications 32. The application servers 28 are, in turn, shown to be coupled to one or more database served(s) 35 that facilitate access to one or more databases 36.

The financial institution applications 30 provide a number of financial functions and services to users that access the network-based financial institution 12. The payment applications 32 likewise provide a number of payment services and functions to users. The payment applications 32 may allow users to qualify for, and accumulate, value (e.g., in a commercial currency, such as the U.S. dollar, or a proprietary currency, such as “points”) in accounts, and then later to redeem the accumulated value for products (e.g., goods or services) that are made available via the financial institution applications 30. While the financial institution and payment applications 30 and 32, respectively, are shown in FIG. 1 to both form part of the network-based financial institution 12, it will be appreciated that, in alternative embodiments of the present disclosure, the payment applications 32 may form part of a payment service that is separate and distinct from the network-based financial institution 12. The network-based financial institution 12 may be embodied as eBay®, the world's online marketplace, provided by eBay of San Jose, Calif.

In some instances, the social applications 31 or other applications implementing portions of the functionality of the social applications 31 may reside within or be hosted by the application servers 28 at the network-based financial institution 12. In other embodiments, the application servers 28 may access the social applications 31 or receive social data from the social applications 31. The application servers 28 may generate a plurality of user interfaces viewed at the client machines 20, 22 that include social network data. Further, the application servers 28 at the network-based financial institution 12 may receive social network data from a user and selectively transmit portions of the received data to the social applications 31 at the network-based social platform 13.

Further, while the system 100 shown in FIG. 1 employs a client-server architecture and a peer-to-peer architecture, the present disclosure is of course not limited to such an architecture, and could equally well find applications in any combination of client-server, distributed, or peer-to-peer, architecture systems. The various marketplace and payment applications 30 and 32 could also be implemented as standalone software programs, which do not necessarily have networking capabilities.

The web client 16, it will be appreciated, accesses the various financial institution and payment applications 30 and 32 via the web interface supported by the web server 26. Similarly, the programmatic client 18 accesses the various services and functions provided by the financial institution and payment applications 30 and 32 via the programmatic interface provided by the API server 24. The programmatic client 18 may, for example, be a merchant application to enable merchants to process transactions (e.g., request and accept payments, generate receipts, and generate invoices) using the network-based financial institution 12 in an off-line manner, and to perform batch-mode communications between the programmatic client 18 and the network-based financial institution 12.

It will be appreciated that the financial institution applications 30, payment applications 32, social applications 31, the network-based financial institution interface module 33, the communication module 39, and the processing module 41 may execute on a single platform. Accordingly, in one embodiment, the aforementioned applications/modules may execute on the network-based financial institution 12 and in another embodiment, the aforementioned applications/module may execute on the network-based social platform 13.

FIG. 1 also illustrated a third-party application 38, executing on a third-party server machine 40, as having programmatic access to the network-based financial institution 12 via the programmatic interface provided by the API server 24. For example, the third-party application 38 may, utilizing information retrieved from the network-based financial institution 12, support one or more features or functions on a website hosted by the third party. The third-party website may, for example, provide one or more promotional, marketplace or payment functions that are supported by the relevant applications of the network-based financial institution 12.

### Social Platform Applications

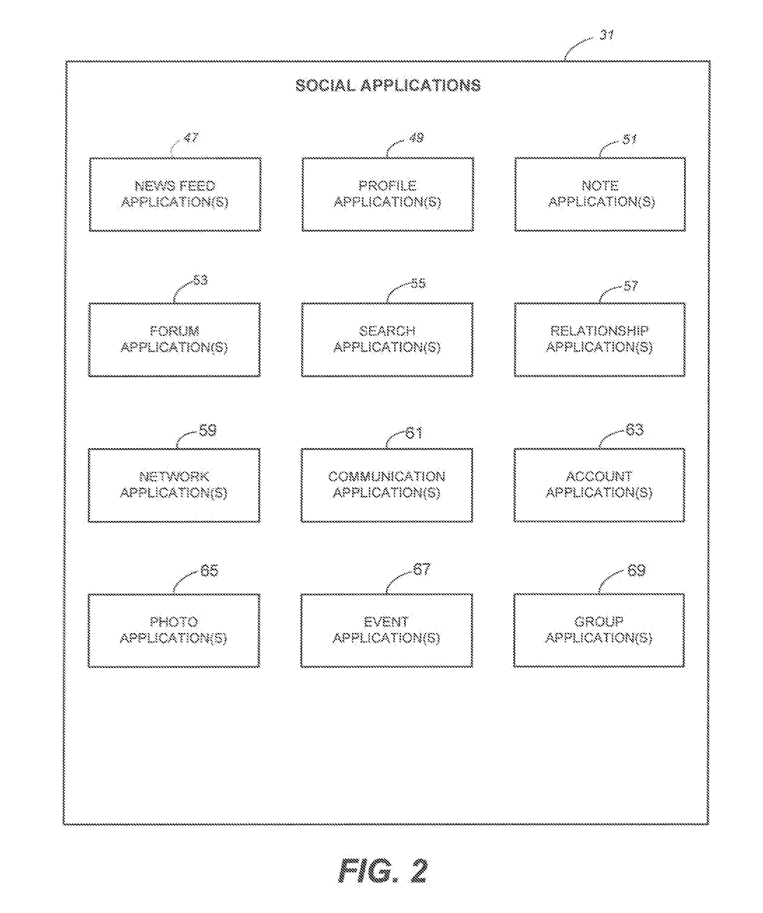

FIG. 2 is a block diagram illustrating social applications 31 that execute on the network-based social platform 13, according to an embodiment. The network-based social platform applications 31 include news feed applications 47, profile applications 49, not applications 51, forum applications 53, search applications 55, relationship applications 57, network applications 59, communication applications 61, account applications 63, photo applications 65, event applications 67, and group applications 69.

The news feed applications 47 publish events associated with the user and friends of the user on the network-based social platform 13. The news feed applications 47 may publish the events on the user profile of a user. For example, the news feed applications 47 may publish the uploading of a photo album by one user on the user profile of the user and the user profiles of friends of the user.

The profile applications 49 may maintain user profiles for each of the users on the network-based social platform 13. Further, the profile applications 49 may enable a user to restrict access to selected parts of their profile to prevent viewing by other users. The note applications 51 may be used to author notes that may be published on various user interfaces.

The forum applications 53 may maintain a forum for users to post comments and display the forum via the profile associated with a user. The user may add comments to the forum, remove comments from the forum, and restrict visibility to other users. In addition, other users may post comments to the forum.

The search applications 55 may enable a user to perform a keyword search for users, groups, and events. In addition, the search applications 55 may enable a user to search for content (e.g., favorite movies) on profiles accessible to the user.

The relationship applications 56 may maintain relationship information for the users. The network applications 59 may facilitate the addition of social networks by a user, with the social networks based on a school, workplace, or region, or any social construct for which the user may prove an affiliation. The communication applications 61 may process incoming and outgoing messages, maintain an inbox for each user, facilitate sharing of content, facilitate interaction among friends (e.g., poking), process requests, process events, process group invitations, and process communicating notifications.

The account applications 63 may provide services to facilitate registering, updating, and deleting user accounts. The photo applications 65 may provide services to upload photographs, arrange photographs, set privacy options for albums, and tag photographs with text strings. The event applications 67 may provide services to create events, review upcoming events, and review past events. The group applications 69 may be used to maintain group information, display group information, and navigate to groups.

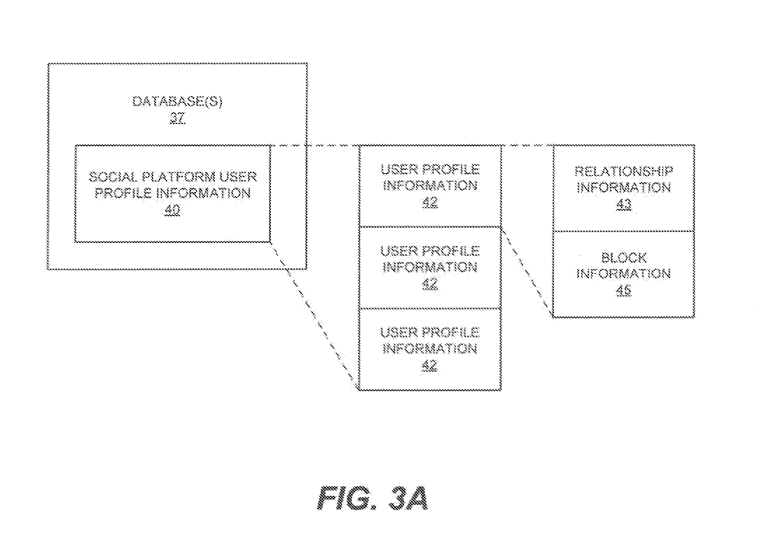

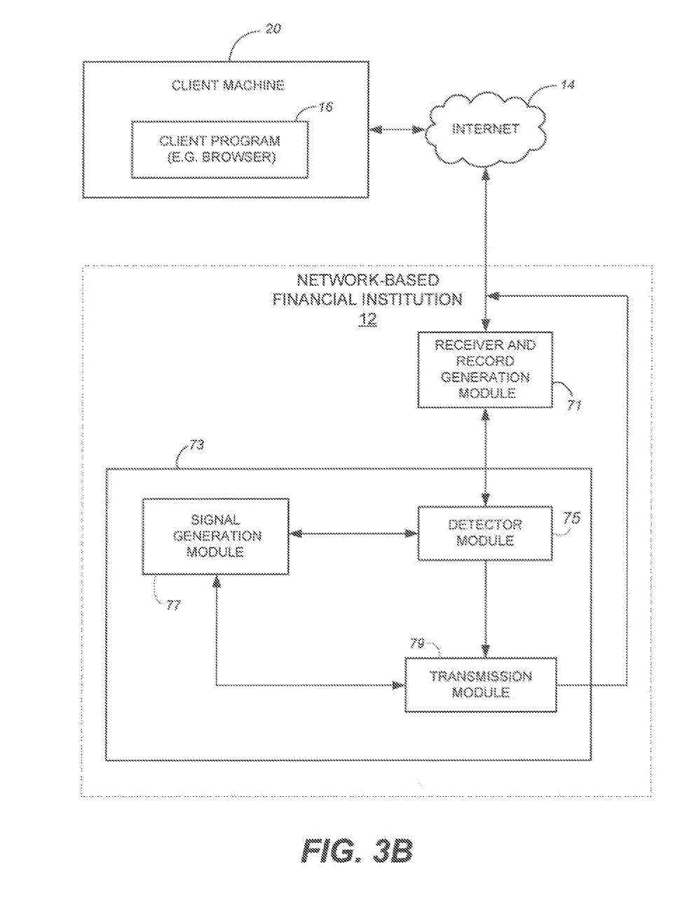

FIG. 3A is a block diagram illustrating a database 37, according to an embodiment, at the network-based social platform 13 of FIG. 1. The database 37 is shown to include social platform user profile information 40 that stores user profile information 42 for each user on the network-based social platform 13. The user profile information 42 may include information related to the user and specifically may include relationship information 43 and block information 45. The relationship information 43 may store a predetermined relationship between the user associated with the user profile information 42 and other users on the network-based social platform 13. For example, a first user may be designated a “friend,” “favorite friend,” or the like, with a second user, with the first user associated with the user profile information 42 and the respective designations associated with increasing levels of disclosure between the first user and second user. The block information 45 may store a configured preference of the user to block the addition of an item by other users to the watch list associated with the user. In some instances, one or more components of the network-based financial institution 12 of FIG. 1 may be able to access specified portions of the database 37 via, for example, a programmatic interface.

Turning to FIG. 3B, there is seen a system that may form part of the network-based financial institution 12 of FIG. 1. The network-based financial institution 12 is shown in part in the drawing to make it clear that the system forms only a part of the network-based financial institution 12. The system includes a receiver and record generation module 71 for receiving signals from client machine 20 or the network-based social platform 13, the signals identifying content to be transmitted to a social network server for storing at a message space of a user of the social network server or to be transmitted to the client machine 20, respectively. An additional function of the receiver and record generation module 21 may be to generate a transaction record from a transaction by the user. As used herein, “signals” could mean analog signals or digital signals such as web-based messages, including packet-based messages, or even a request message via an API call. Also included is analysis module 73. The analysts module 73 may include a detector module 75 responsive to signals received by the receiver module 71 for detecting the content, the identity of the social network, and the identity of the user of the social network. The analysis module 73 may also include a signal generation module 77 coupled to the detector module 75 responsive to signals detected by the detector module, such as, for example, signals identifying the content, the identity of the social network, and the identity of the user of the social network, for whom the content is intended, and other types of signals.

The signal generation module 77 may provide a rendering signal for rendering at least the content of the received signal. This rendering signal may be transmitted by transmission module 79 via network 14 to a social network, not shown. Alternatively, instead of transmitting signals via the network to a social network server, the transmission module 79 may transmit the signals, either via the network 14 or internally to the network-based financial institution 12, to a social platform integrated within a network-based financial institution 12. Further, the signals from signal generation module 77 may include signals such as records of transactions or portions thereof, signals requesting no opinion about the transactions from a user of the social network, or for chatting, questions, or additional suggestions about transactions, among other things, as more fully discussed below. The signals may include other types of data suck as links to websites, reviews, emails, calendar appointments, pictures or images, user-specified projects, records of transactions completed using other payment systems, or the like. The foregoing may be termed “commentary” at various places herein. Such commentary may include one, or any combination of, the foregoing.

### Social Networking Platform Integration for a Network-Based Financial Institution

A network-based financial institution user or a person accessing or browsing anywhere on the Internet, may share purchases (based on one or more records of transactions completed using the payment applications 32 of FIG. 1) or prospective purchases with friends on a social networking platform (e.g., Facebook.com or a platform integrated within an ecommerce marketplace or other publication system). These purchases of items identified in records of transactions and other goods or services similarly shared with friends as discussed herein, may be termed “commercial items,” or simply “items.” For example, within the ecommerce marketplace shopping flow, the user may be provided with the ability to post her transaction involving a commercial item to a social network wall. This wall concept is sometimes referred to herein as “storage spaced,” and could include renderable or viewable storage space. The user may tag a post with friends so that it shows up in their social graph(s). The post may include a picture and certain item or transaction information. Further, the friend may be provided with a user selectable “See Similar” function to see similar records of transactions performed by the transacting user or by other friends of the friend, pictures, and item information. Typically a selection button for such a function may be located adjacent to the record of the transaction, an item description, advertisement for the item, or adjacent the item's photo, as a link. It could also be added as a contextual pop-up. The shared post may include a selection like “commentable” or “likeable.” These cases describe interactions that may feed into a social network (for example, Facebook). “Commentable” means that the marketplace user may share a particular product or item with his or her social graph via the Facebook Wall and include a comment along with it. “Likeable” means a Facebook user may provide a Facebook thumbs up if he or she likes the transaction, product, or item. A social network user may also be able to provide a thumbs down if he or she doesn't like the product or item.

### Get an Opinion or Other Information Using a Social Platform

An ecommerce marketplace user may solicit the opinions of friends about a transaction performed using the network-based financial institution 12. To do this, the user may push at least a portion of a record describing a transaction to a social networking platform in the form of a poll. Other uses of social networks for shopping, or shopping information, may also be used.

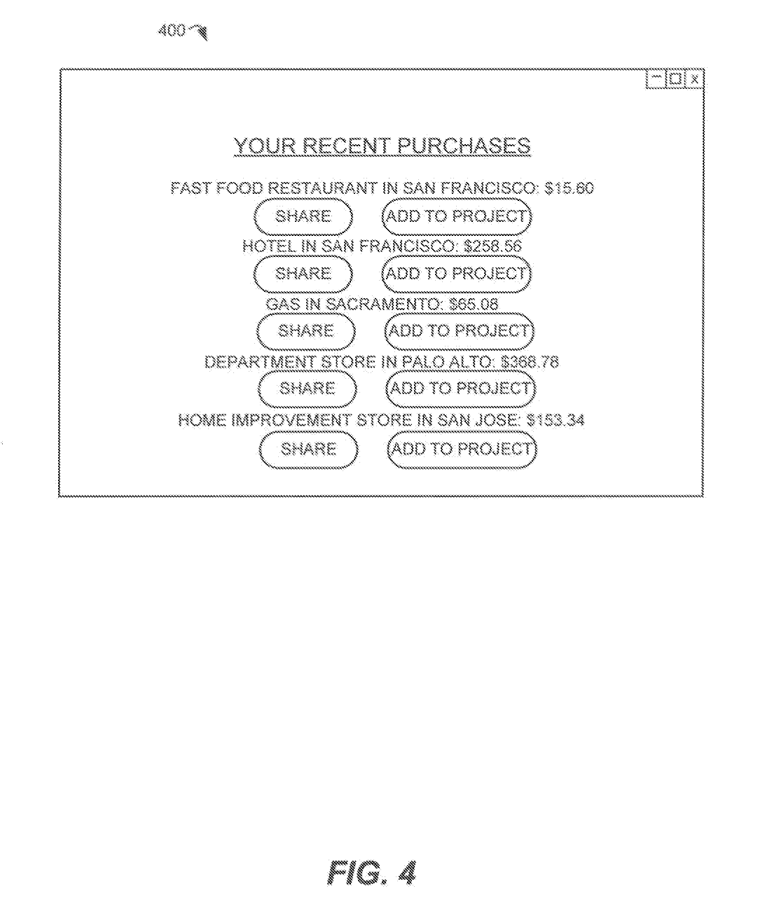

For example, as depicted in FIG. 4, an interface 400 may be provided to a user by the network-based financial institution 12, solely or in combination with, the network-based social platform 13. The interface 400 includes a list including descriptions of a number or recent transactions performed by the user. The descriptions may include an amount paid by the user or to the user, an identification or description of the other party to the transaction (e.g., a merchant), a description of the items purchased as pan of the transaction, a time of the transaction, and/or a geographical location where the transaction occurred.

The interface 400 may leather include one or more options for managing the respective transactions or at least a portion of the transactions as a set or a batch. The options may include, for example, sharing at least a portion of the description of the transaction via the network-based financial institution 12 or the network-based social platform 13.

Another option provided in interface 400 may include adding the transaction to a “project” such as by the ADD TO PROJECT radio button of FIG. 4. A project, as used herein, is a user-defined set of transactions that are closely related to a larger goal or task defined by the user. Examples of projects may include transactions made for travel on a trip, a home improvement project, a group purchase, a holiday, or other event or goal; transactions that may be tax-deductible; or transactions that are business-related.

In some embodiments, the interface 400 or another interface may include descriptions of transactions that were processed using other financial institutions. These may be accessed directly from the other financial institutions or using a data management service such as MINT.COM or YODLEE.COM

The interface 400 and other interfaces described herein may be provided as part of a stand-alone website or be provided as a toolbar or widget in a separate website, such as a social networking website, email client, browser-based email webpage, or on a user's desktop. For example, an interface similar to interface 400 may be provided as a widget on a newsfeed page provided to the user by FACEBOOK. From the widget, the user may select a description of a transaction to share with one or more friends by, in one embodiment, using the SHARE radio button of FIG. 4. In browser-based email, the list may be included adjacent to a compose email interface to allow a user to add the transaction or a link to the transaction to an email message or to allow the user to link the composed email to the transaction. On a website that provides reviews of items, a widget may allow a user to attach a review to a transaction for the user's reference or to attach a transaction to a review so other users of the website can view portions of the transaction. Similar widgets can be used in calendar applications, spreadsheet applications, chat applications, and other applications.

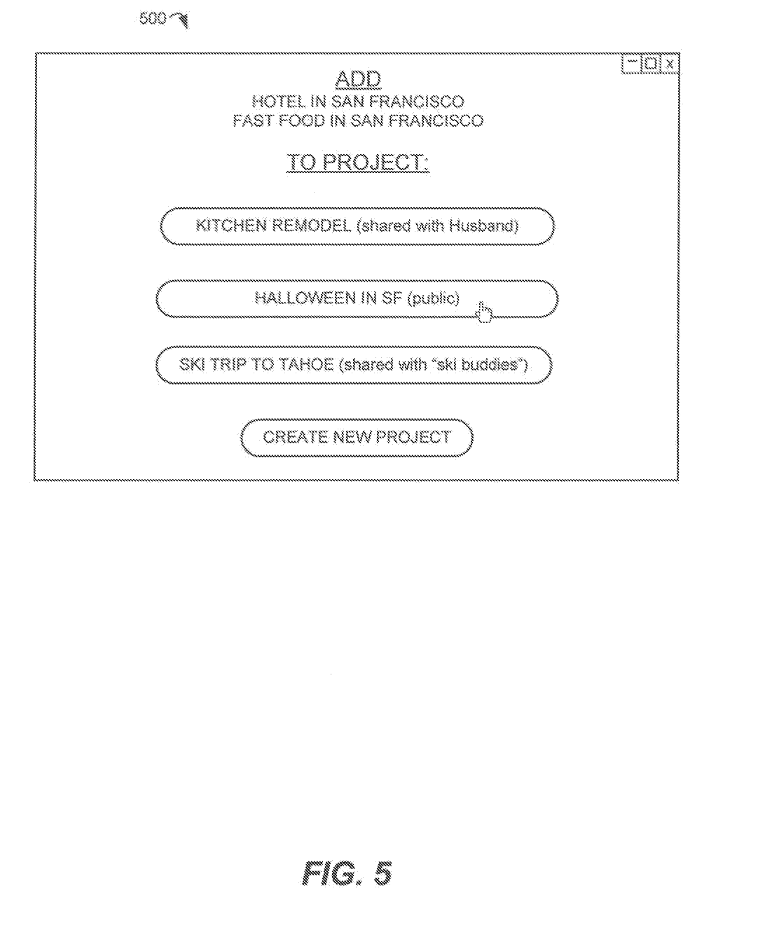

FIG. 5 depicts a portion of an interface 500 that may be presented to a user who selects art option to add a transaction to a project. The user may select one or more transactions front the interface 400. The interface 500 then lists or otherwise presents to the user projects defined by the user. The user may select one or more projects to which the transactions are added. For example, a user may select to add a transaction purchasing plane tickets to Hawaii to projects labeled “holiday gifts” and “travel to Hawaii” (not shown). As depicted in FIG. 5, a user may select two transactions and choose to add them to project “Halloween in SF”.

In some instances, transactions may be automatically assigned to a project based on characteristics of the transaction. For example, if a group relates to a kitchen remodel, the network-based financial institution 12 may determine that purchases made at a home improvement store or that include items sold in home improvement categories belong in the “kitchen remodel” project. In some instances, an option is provided to the user to confirm the addition of the transaction to the project. In other instances, the transaction may be added to the transaction and the user is given an option to remove the transaction from the project. In some embodiments, if the user composes an email, a widget may provide the user with an option to add the email to the project. Similar options may be provided if the user does other related activities online such as writing a review, creating an appointment in an application, chatting with a service provider, uploading an image, or the like.

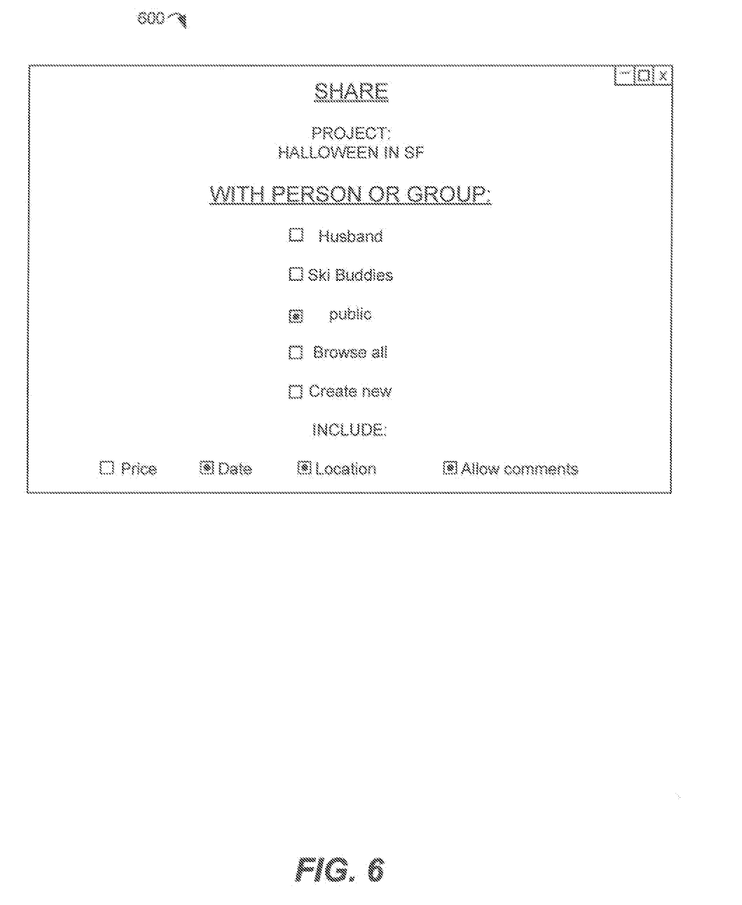

FIG. 6 depicts an interface 600 that allows a user to share protects or transactions with other users. Upon selecting an optima in another interface (e.g., interface 400 or interface 500 (not shown on FIG. 6)) to share one or more transactions or projects with particular users or groups of users defined in the network-based financial institution 12, solely or in combination with the network-based social platform 13. The interface 600 may further allow the user to select aspects of the transaction to share or to keep private as depicted near the bottom of interface 600. The aspects may include price, date, location, merchant, item descriptions or identifiers, and the like. The user may further dictate what other users may do in connection with the transaction, such as make comments about the transaction, share the transaction with others, or the like.

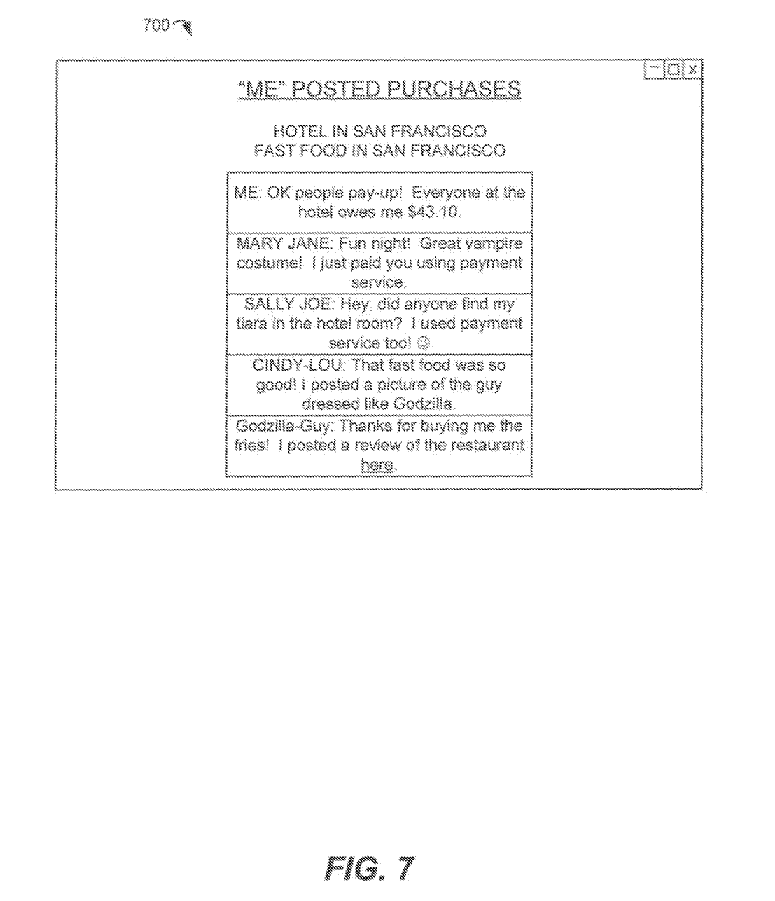

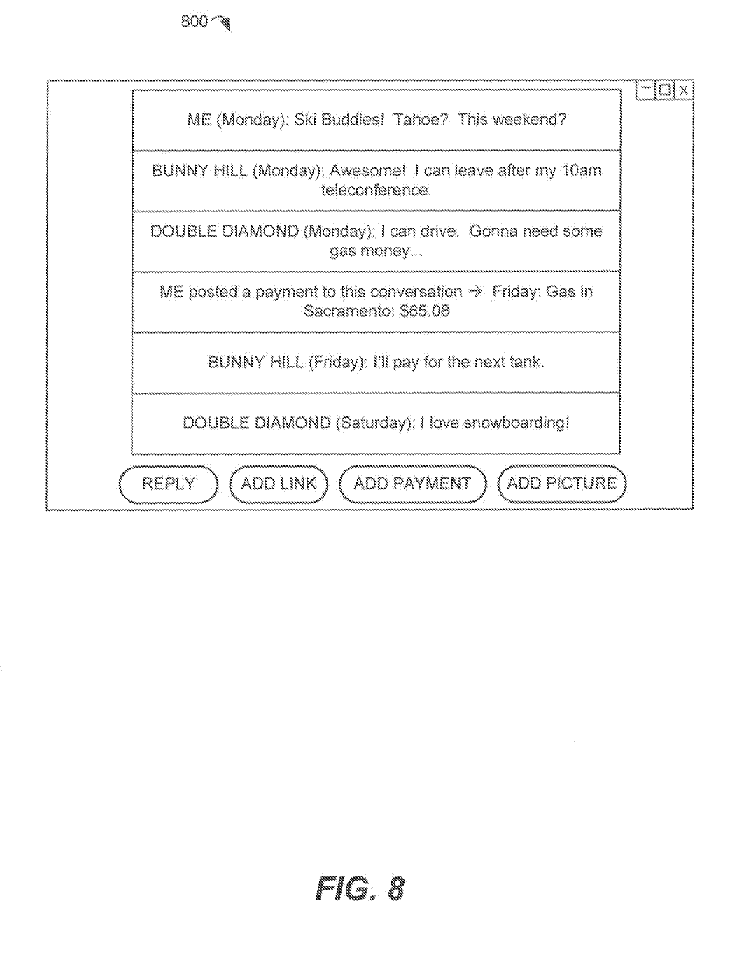

FIG. 7 depicts a portion of a user interface 700 that may be provided as part of a newsfeed by the network-based social platform 13. In the user interface 700, the user has started a conversation by posting two transactions (HOTEL IN SAN FRANCISCO and FAST FOOD IN SAN FRANCISCO) as a status messages. The description of the transaction may include text, images, video, audio, or the like. In some cases, for example if the transactions included purchased items, pictures of the items purchased may be accessed from another source, such as an online marketplace based on an item identifier. The user and the user's friends may then comment on the transactions, or provide links to other content. In other instances, and as depicted in interface 800 of FIG. 8, the description of the transactions may be added as a easement on an existing thread or as part of an existing conversation.,

In some instances, the user may be prompted to add a transaction to commentary based on information included in the commentary. For example, if a merchant is identified in the commentary, and the user has recently transacted with the merchant, a suggestion may be made to add the transaction to the commentary. The suggestion may also be based on geographic location, approximate payment amount, friends near the user or the merchant when the transaction was completed (e.g., based on check-ins), and the like.

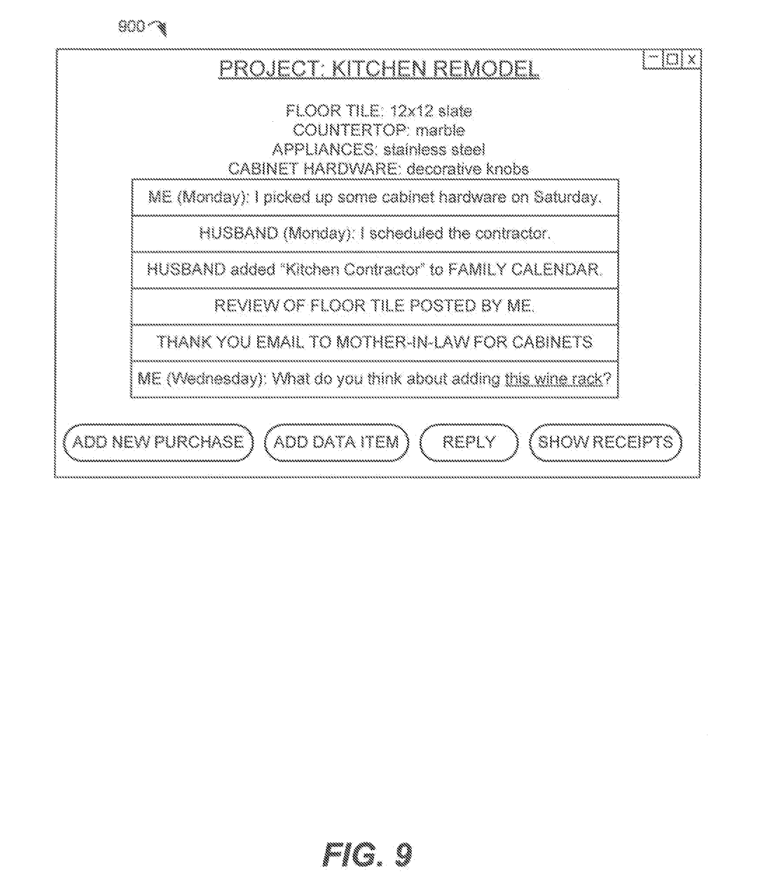

FIG. 9 depicts a commentary developed as part of a project. The commentary associated with a project may include, for example, a list of items purchased, comments, appointments, online reviews, emails, and links related to the project.

The foregoing description illustrates a user of an ecommerce site, here the originator, as one example, shopping socially with people, such as the participants, who have a common interest with the user. The interest may be, as one example, shopping for fashion items on the eBay site. The participants may be friends on Facebook, or may be a following on Twitter. The user-originator may decide to shop with participants because the originator likes the styles suggested by the participants. The social shopping described may even be accomplished anonymously by creating polls, and the like, for groups who shop on Fashion pages on eBay. Opt-in for such anonymous shopping may be provided, and polls, chats, votes, and the like, can be communicated by email, chat, SMS, or other types of communication to participants who opt-in.

### Flow Charts

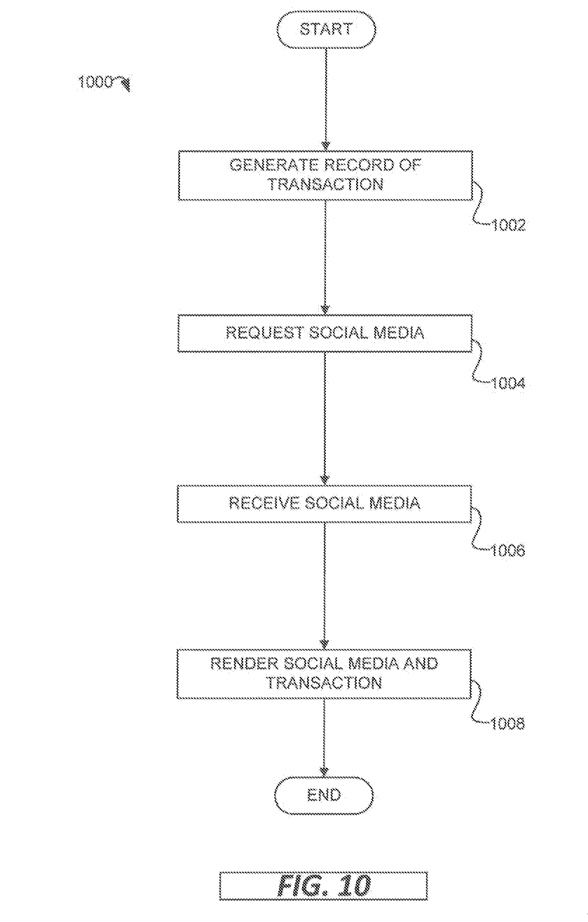

A flowchart 1000 of an example embodiment is provided in FIG. 10, according to an embodiment. The operations illustrated in flowchart 1000 may be performed by the network-based financial institution 12 or the network-based social platform 13.

In an operation 1002, a record of a transaction performed by a user is generated. The record may include the role of the user (e.g., payer or payee), the amount paid, the date and time of the transaction, the geographical location of the transaction, the other party to the transaction (e.g., a merchant identifier), items exchanged as part of the transaction, a description or link to a description of the items exchanged, or the like. The record of the transaction may be generated by the network-based financial institution 12, by another payment service, or accessed via a data management service.

In some instances, the operation 1002 of generating a record of the transaction may be performed by the Receiver and Record Generation Module 71 from data supplied via network 14. The detector module 75 may cull search terms from the record of the transaction and further identify additional search terms based on the culled search terms. For example, based on an item identifier, such as a bar code, the detector module 75 may access a description of the item and cull further search terms from the description.

In an operation 1004, a request for social media data related to the transaction and about the user is transmitted to the network-based social platform 13 by the transmission module 79 via network 14. The request may include an identifier of the user and at least a portion of the search terms. In some instances, a portion of the record of the transaction may be transmitted to the network-based social platform.

In operation 1006, the social media data may be received by the receiver module 71. The receiver module 71 may further receive, from the user, an assignment of the record of transaction to a project, an indication that a person or group is granted access to at least a portion of the record of the transaction, an instruction to make a portion of the record of the transaction accessible to a person, an instruction to assign online content to the record of the transaction, an instruction to assign a comment to the record of the transaction, or an instruction to assign a second, record of a second transaction to a project.

In an operation 1008, a rendering signal instructing a client device to render at least a portion of the record of the transaction and the at least one piece of social media data is provided by the signal generation module 77. The signal generation module 77 may further instruct the client device, by way of transmission module 79, to render an indication of an assignment of the record of transaction to a project, an indication of access to at least a portion of the record of the transaction granted to a person or group, an instruction to a second client device used by a person to render the portion of the record of the transaction, include a portion of the online content or a link to the online content rendered adjacent to the tendering of the at least the portion of the record of the transaction, a comment adjacent to with the rendering of the at least the portion of the record of the transaction, or a portion of a second record of a second transaction adjacent to the rendering of the project.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It may be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 21 is a block diagram of machine in the example form of a computer system 300 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a dish drive unit 316, a signal generation device 318 (e.g., a speaker) and a network interface device 320.

### Machine-Readable Medium

The disk drive unit 316 includes a machine-readable medium 322 on which is stored one or more sets of data structures and instructions 324 (e.g., software) embodying or utilized by any one or more of the methodologies or functions described herein. The instructions 324 may also reside, completely or at least partially, within the main memory 304, static memory 306, and/or within the processor 302 during execution thereof by the computer system 300, the main memory 304 and the processor 302 also constituting machine-readable media.

While the machine-readable medium 322 is shown in an example embodiment to be a single medium, the term “machine-readable medium” may include a single medium or multiple media (e.g., a centralized or distributed database, and/or associated caches and servers) that store the one or more instructions 324 or data structures. The term “machine-readable medium” shall also be taken to include any tangible medium that is capable of storing, encoding or carrying instructions for execution by the machine and that cause the machine to perform any one or more of the methodologies of the described implementations, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices;

magnetic disks such as internal hard disks and removable disks; magneto-optical disks; and CD-ROM and DVD-ROM disks.

### Transmission Medium

The instructions 324 may further be transmitted or received over a communications network 326 using a transmission medium. The instructions 324 may be transmitted using the network interface device 320 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system, comprising;
a detector module configured to, using one or more processors, generate a record of a transaction performed by a user;
a transmission module configured to send to a network-based social platform a request for social media data related to the transaction and about the user;
a receiver and record generation module configured to receive at least one piece of social media data; and
a signal generation module configured to provide a rendering signal instructing a client device to render at least a portion of the record of the transaction and the at least one piece of social media data.

2. The system of claim 1, wherein the detector module is further configured to cull search terms from the record of the transaction and wherein the request includes at least a portion of the search terms.

3. The system of claim 2, wherein the defector module is further configured to identify further search terms based on the culled search terms.

4. The system of claim 1, wherein the receiver and record generation module is further configured to receive an assignment of the record of transaction to a project and wherein the signal generation module is holder configured to instruct the client device to render an indication of the assignment.

5. The system of claim 1, wherein the transmission module is further configured to transmit at least a portion of the record of the transaction to the network-based social platform.

6. The system of claim 1, wherein the receiver and record generation module is further configured to receive an indication that a person or group is granted access to at least a portion of the record of the transaction and wherein the signal generation module is further configured to instruct the client device to render an indication of the granted access.

7. The system of claim 1, wherein the receiver and record generation module is further configured to receive an instruction to make a portion of the record of the transaction accessible to a person and wherein the signal generation module is further configured to instruct a second client device used by the person to render the portion of the record of the transaction.

8. The system of claim 1, wherein the receiver and record generation module is further configured to receive an instruction to assign online content to the record of the transaction and wherein the signal generation module is further configured to instruct the client device to render a portion of the online content or a link to the online content adjacent to the rendering of the at least the portion of the record of the transaction.

9. The system of claim 1, wherein the receiver and record generation module is further configured to receive an instruction to assign a comment to the record of the transaction and wherein the signal generation module is further configured to instruct the client device to render the comment adjacent to with the rendering of the at least the portion of the record of the transaction.

10. The system of claim 1, wherein the receiver and record generation module is further configured to receive an instruction to assign a second record of a second transaction to a project and wherein the signal generation module is further configured to instruct the client device to render a portion of the second record of the second transaction adjacent to the rendering of the project.

11. A method comprising:
using one or more processors, generating a record of a transaction performed by a user;
sending a request for social media data related to the transaction and about the user to a network-based social platform;
receiving at least one piece of social media data; and
providing a rendering signal instructing a client device to render at least a portion of the record of the transaction and the at least one piece of social media data.

12. The method of claim 11, further comprising culling search terms from the record of the transaction and wherein the request includes at least a portion of the search terms.

13. The method of claim 12, further comprising identifying further search terms based on the culled search terms.

14. The method of claim 11, further comprising receiving an assignment of the record of transaction to a project and storing the assignment to the project and further comprising instructing the client device to render an indication of the assignment.

15. The method of claim 11, further comprising transmitting at least a portion of the record of the transaction to the network-based social platform.

16. The method of claim 11, further comprising receiving an indication that a person or group is granted access to at least a portion of the record of the transaction and instructing the client device to tender an indication of the granted access.

17. The method of claim 11, further comprising receiving an instruction to make a portion of the record of the transaction accessible to a person and instructing a second client device used by the person to render the portion of the record of the transaction.

18. The method of claim 11, further comprising receiving an instruction to assign online content to the record of the transaction and instructing the client device to render a portion of the online content or a link to the online content adjacent to the rendering of the at least the portion of the record of the transaction.

19. The method of claim 11, further comprising receiving an instruction to assign a comment to the record of the transaction and instructing the client device to render the comment adjacent to with the rendering of the at least the portion of the record of the transaction.

20. A non-transitory computer-readable medium having instructions embodied thereon, the instructions executable by one or more processors for performing operations comprising:
generating a record of a transaction performed by a user;
sending a request for social media data related to the transaction and about the user to a network-based social platform;
receiving at least one piece of social media data; and
providing a rendering signal instructing a client device in render at least a portion of the record of the transaction and the at least one piece of social media data.
